(19) United States
(12) Patent Application Publication
(10) Pub. No.: US 2022/0235873 A1
(43) Pub. Date: Jul. 28, 2022

(54) VACUUM SEWAGE SYSTEMS WITH CHECK VALVES AND CHECK VALVES FOR VACUUM SEWAGE SYSTEMS

(71) Applicant: Aqseptence Group, Inc., Rochester, IN (US)

(72) Inventor: Troy E. Blocher, Warsaw, IN (US)

(73) Assignee: Aqseptence Group, Inc., Rochester, IN (US)

(21) Appl. No.: 17/158,293

(22) Filed: Jan. 26, 2021

(51) Int. Cl. F16K 15/02; E03F 5/22

(52) U.S. Cl. CPC F16K 15/026; E03F 5/22

(57) ABSTRACT

A vacuum sewage system includes a check valve having a body, a sealing member and a cover. The body includes a housing. The sealing member has a first section and a central section connected to the first section. The central section of the sealing member has a sealing surface. The cover has an interior chamber, a connector having a passageway in communication with the interior chamber, and a front wall having a central section. The central section of the front wall has a sealing surface. The central section of the sealing member is moveable from a first position in which the sealing surface of the sealing member is in contact with the sealing surface of the central section of the front wall of the cover to a second position in which the sealing surface of the central section of the sealing member is spaced apart from the sealing surface of the central section of the front wall of the cover.

The present invention relates generally to sewage systems which utilize differential pressures to produce sewage transport through the system, which are commonly referred to as “vacuum sewage systems” and, in particular, to vacuum sewage systems having a check valve and to check valves for vacuum sewage system.

### BACKGROUND AND SUMMARY OF THE INVENTION

Vacuum sewage systems typically employ a valve and a controller that opens the valve under certain operating conditions in order to discharge accumulated sewage from a collection tank, through the valve, and to a collection station via a discharge conduit. Under certain operating conditions, backpressure can occur that tends to force sewage from the discharge conduit into the controller. Certain prior art systems have utilized check valves in order to prevent sewage from being forced from the discharge conduit into the controller under such backpressure conditions. An example of such a check valve is shown in U.S. Pat. No. 4,171,853.

In one embodiment of the present invention, a check valve for a vacuum sewage system includes a body, a sealing member, a cover, and a retaining member. The body includes a post and a housing. The post has a first end, a second end, and a passageway extending from the first end to the second end. The housing has a groove, an open end, a flange disposed about the open end and having a protrusion, a closed end, and a chamber in fluid communication with the post passageway. The chamber has a floor disposed at an angle to the post passageway, a first sealing surface and a second sealing surface. The sealing member has a front face, a first section having a protrusion, a second section extending from first section, a third section extending from second section, a curved section connected to third section and having at least one opening, and a central section connected to curved the section. The central section of the sealing member has a sealing surface. The cover includes an open end, a side wall having a protrusion, a beveled edge and an inner surface, a front wall having a central section having a sealing surface, an interior chamber, an interior groove, and a connector extending from the front wall. The connector has a passageway in communication with the interior chamber. The retaining member is located in the groove of the housing and secures the cover to the housing. The retaining member has a first end, a second end and an opening between the first end and the second end. The flange of the housing is located in the interior groove of the cover. The second section of the sealing member is located between the first sealing surface of the housing chamber and the front wall of the cover. The second section of the sealing member is located adjacent the second sealing surface of the housing chamber. The protrusion of the sealing member is located in the protrusion of the housing. The protrusion of the sealing member and the protrusion of the housing flange are located in the protrusion of the cover.

In one embodiment, at least a portion of the floor of the chamber housing angles downwardly from the open end toward the post passageway.

In another embodiment, the central section of the sealing member is moveable from a first position in which the sealing surface of the sealing member is in contact with the sealing surface of the central section of the front wall of the cover, to a second position in which the sealing surface of the central section of the sealing member is spaced apart from the sealing surface of the central section of the front wall of the cover. In certain embodiments, the sealing surface of the central section of the sealing member closes one end of the connector passageway when the central section of the sealing member is in the first position. In another embodiment, an annular space is formed around the central section of the front wall of the cover and between the curved section of the sealing member and the front wall of the cover when the central section of the sealing member is in the first position.

In certain embodiments of the invention, the at least one opening in the sealing member is larger than the smallest cross-section of the connector passageway. In another embodiment, the smallest cross-section of the post passageway is larger than the smallest cross-section of the connector passageway. In some embodiments, the at least one opening in the sealing member and the smallest cross-section of the post passageway are both larger than the smallest cross-section of the connector passageway.

In other embodiments, the retaining member exerts outward force on the inner surface of the sidewall of the cover.

In another embodiment, the housing further includes a port for connection to an electronic air admission controller. In one embodiment, the housing further includes a connector for a device for monitoring the operational state of the vacuum sewage system.

In one embodiment of the present invention, a check valve for a vacuum sewage system has a body, a sealing member and a cover. The body includes a housing. The sealing member has a first section and a central section connected to the first section. The central section of the sealing member has a sealing surface. The cover has an interior chamber, a connector having a passageway in communication with the interior chamber, and a front wall having a central section. The central section of the front wall has a sealing surface. The central section of the sealing member is moveable from a first position in which the sealing surface of the sealing member is in contact with the sealing surface of the central section of the front wall of the cover, to a second position in which the sealing surface of the central section of the sealing member is spaced apart from the sealing surface of the central section of the front wall of the cover.

In one embodiment, the sealing surface of the central section of the sealing member closes one end of the connector passageway when the central section of the sealing member is in the first position.

In other embodiments, an annular space is formed around the central section of the front wall of the cover and between the first section of the sealing member and the front wall of the cover when the central section of the sealing member is in the first position.

In certain embodiments, the sealing member includes at least one opening. In one embodiment, the at least one opening is in the first section of the sealing member. In another embodiment, the at least one opening in the sealing member is larger than the smallest cross-section of the connector passageway. In a further embodiment, the opening in the sealing member is fluid communication with the annular space.

In other embodiments, the housing includes an open end and a chamber, and the body further includes a post having a first end, a second, and a passageway in fluid communication with the chamber and extending from the first end of the post to the second end of the post. In certain embodiments, the chamber includes a floor, at least a portion of which angles downwardly from the open end toward the post passageway.

In one embodiment of the present invention, a check valve for a vacuum sewage system includes a body, a cover and a sealing member, The body includes a housing. The cover includes an interior chamber, a connector having a passageway in communication with the interior chamber, and a front wall having a central section. The central section of the front wall has a sealing surface. The sealing member has a first section and a central section connected to the first section. The central section of the sealing member has a sealing surface facing the front wall of the cover. The check valve further includes means for facilitating the passage of fluid from between the sealing member and the front wall of the cover to the opposite side of the sealing member.

In one embodiment, the means for facilitating the passage of fluid includes at least one opening in the sealing member.

In one embodiment of the present invention, a vacuum sewage system includes a controller, a vacuum pump for providing vacuum to the vacuum sewage system and to the controller, and a check valve. The check valve has a cracking pressure sufficiently low so as to not cause a reduction of the vacuum supply to the controller upon opening of the check valve.

In one embodiment, the cracking pressure is less than 1 inch of mercury vacuum. In other embodiments, the controller is actuated at a vacuum pressure of 5 inches of mercury.

In certain embodiments, the rate of air flow through the check valve is greater than the rate of air flow through the controller.

These and other features of the present invention will be apparent to those of ordinary skill in the art from the following Detailed Description of Embodiments of the Invention and the accompanying drawings.

### BRIEF DESCRIPTION OF THE DRAWINGS

FIG. 1 is a plan view of a section of a vacuum sewage system according to one embodiment of the present invention.

FIG. 2A is a side perspective view of a controller that is a component of the vacuum, sewage system shown in FIG. 1.

FIG. 2B is a bottom perspective view of the controller shown in FIG. 2A.

FIG. 2C is an end view of the controller shown in FIG. 1.

FIG. 3 is a cross sectional view taken along line 3-3 in FIG. 2C showing the controller in the standby state.

FIG. 3A is an enlarged view of detail 3A in FIG. 3.

FIG. 3B is an enlarged view of detail 3B in FIG. 3.

FIG. 3C is an enlarged view of detail 3C in FIG. 3.

FIG. 3D is an enlarged view of detail 3D in FIG. 3.

FIG. 3E is an enlarged view of detail 3E in FIG. 3.

FIG. 4 is a cross sectional view taken along line 4-4 in FIG. 3.

FIG. 5 is a cross sectional view taken along line 5-5 in FIG. 3.

FIG. 6 is an enlarged view of detail 6 in FIG. 3.

FIG. 7 is a cross sectional view taken along line 3-3 in FIG. 2A showing the controller in the activated state.

FIG. 7A is an enlarged view of detail 7A in FIG. 7.

FIG. 7B is an enlarged view of detail 7B in FIG. 7.

FIG. 7C is an enlarged view of detail 7C in FIG. 7.

FIG. 8 is an exploded perspective view of a check valve according to one embodiment of the present invention that is a component of the vacuum sewage system shown in FIG. 1.

FIG. 9 is a front elevational view of the check valve shown in FIG. 8.

FIG. 10 is a top plan view of the check valve shown in FIG. 8.

FIG. 11 is a cross-sectional view of the check valve shown in FIG. 8 in the standby state.

FIG. 12 is a cross-sectional view of the check valve shown in FIG. 8 in the activated state.

FIG. 13 is an enlarged view of the detail shown in area 13 in FIG. 11.

FIG. 14 is an elevational view of a collection station that is a component of a vacuum sewage system according to one embodiment of the present invention.

### DETAILED DESCRIPTION OF THE EMBODIMENTS OF THE INVENTION

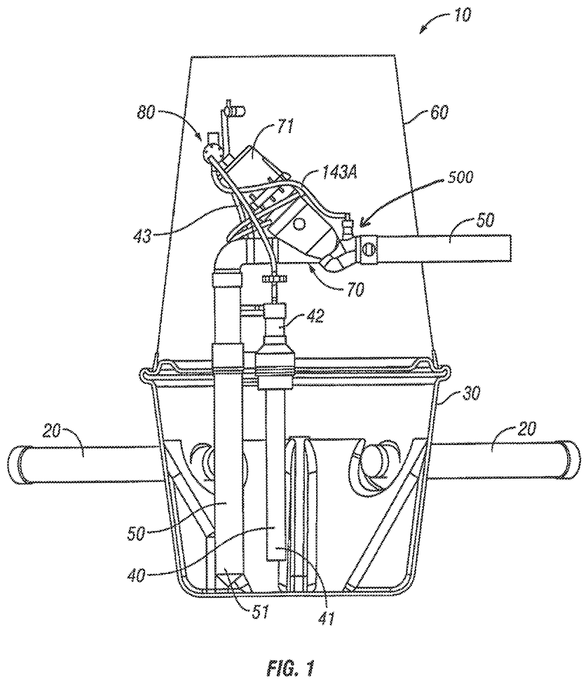

FIG. 1 illustrates a vacuum sewage system 10 including a check valve 500 according to one embodiment of the present invention. System 10 includes gravity sewer conduits 20 at atmospheric pressure which drain from a sewage origination point, such as a toilet. Conduits 20 transport sewage to a holding tank 30, which is maintained at atmospheric pressure. A sensor pipe 40 and a discharge conduit 50 extend into tank 30. A first end 41 of pipe 40 extends downwardly into tank 30 to a point spaced above the inlet opening 51 of a discharge conduit 50. The second end 42 of pipe 40 extends into a valve pit 60.

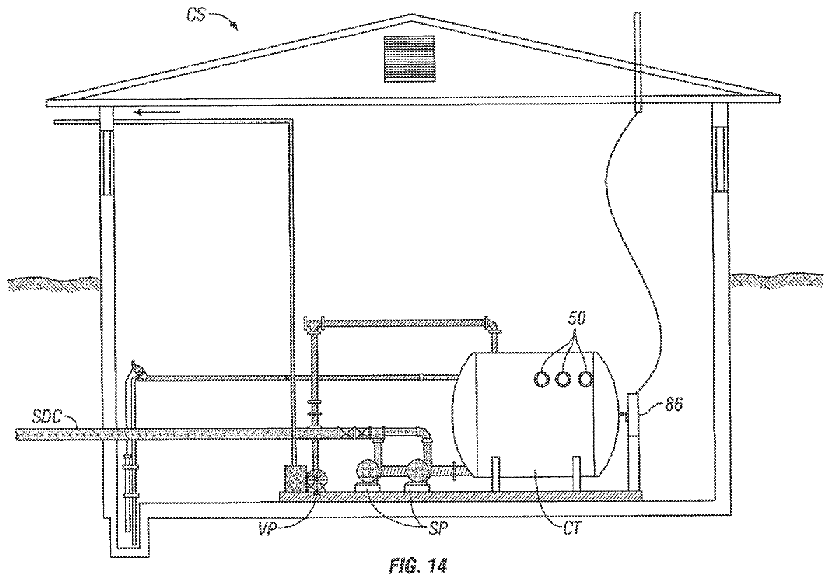

Discharge conduit 50 extends into the valve pit 60 to a valve 70. Numerous types of valves 70 are known in the industry. One example of a valve 70 that can be used with system 10 is disclosed in U.S. Pat. No. 4,171,853. Valve 70 is operated by a controller 80, which will be described in greater detail below. The section of discharge conduit 50 downstream from valve 70 is maintained at vacuum or low pressure by a source of applied vacuum, such as, for example, one or more vacuum pumps VP, which may be located at a collection station CS. (FIG. 14) Vacuum pumps VP are cycled on and off to maintain the vacuum sewage system at the desired vacuum level for proper system operation. Collection station CS also includes a collection tank CT, one or more sewage pumps SP, and a sewage discharge conduit SDC. Vacuum pumps VP draw a vacuum on collection tank CT and through discharge conduits 50. Sewage pumps SP discharge sewage from collection tank CT through sewage discharge conduit SDC to a sewage treatment facility (not shown). Collection stations suitable for use with the present invention are disclosed, for example, in U.S. Pat. Nos. 4,179,371 and 10,316,504.

In use, sewage is discharged through conduit 20 into tank 30. Under preselected pressure conditions in tank 30 (i.e. when the sewage content of tank 30 is such that a discharge cycle is warranted) valve 70 is opened by controller 80. Opening valve 70 creates a differential pressure between the relatively low pressure or vacuum portion of discharge conduit 50 downstream from valve 70 and the relatively higher or atmospheric pressure portion of discharge conduit 50 upstream from valve 70. This pressure differential causes discharge of the sewage in tank 30 through inlet opening 51 of discharge conduit 50, past valve 70, through the portion of discharge conduit 50 downstream from valve 70 and ultimately to collection station CT. Upon completion of the discharge of sewage from tank 30 through the discharge conduit 50, valve 70 is automatically closed and the vacuum sewage transport system of the invention is restored to the standby condition.

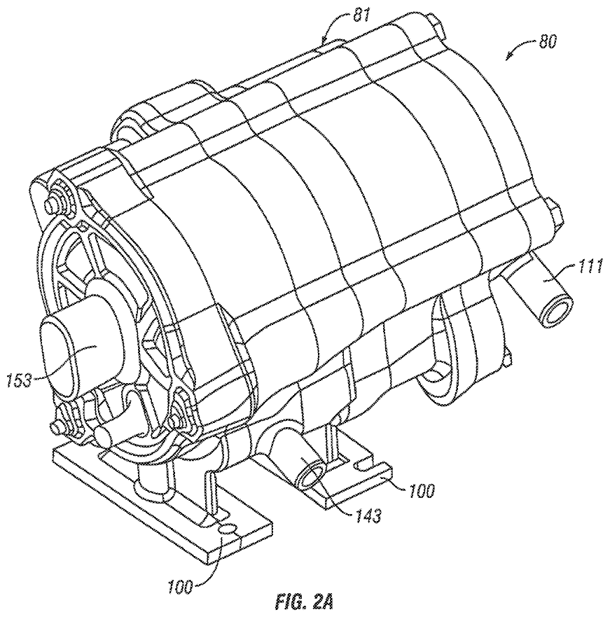

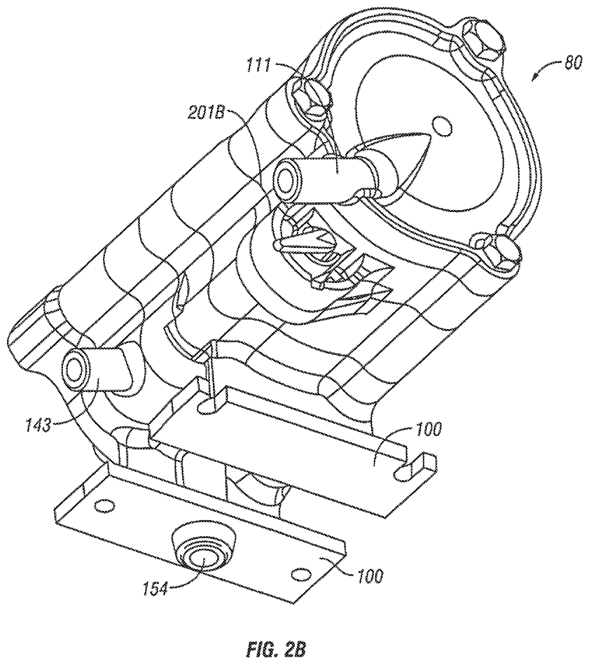

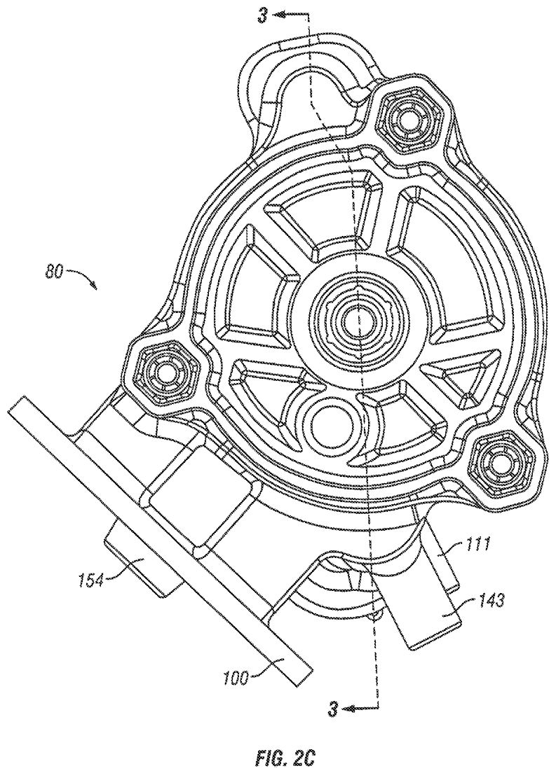

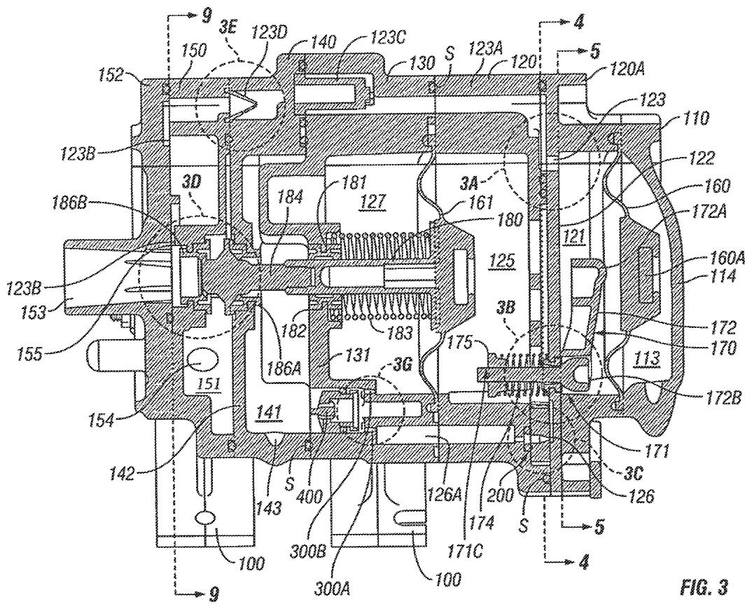

Controller 80 (FIGS. 2A and B) is mounted on valve 70 by one or more brackets 100 or other suitable means. Controller 80 includes a housing 81 formed from an assembly of generally cylindrical and axially aligned sections 110, 120, 120A, 130, 140 and 150. The sections may be secured together by a series of bolts or other fasteners (not shown). Seals S are located between adjacent sections.

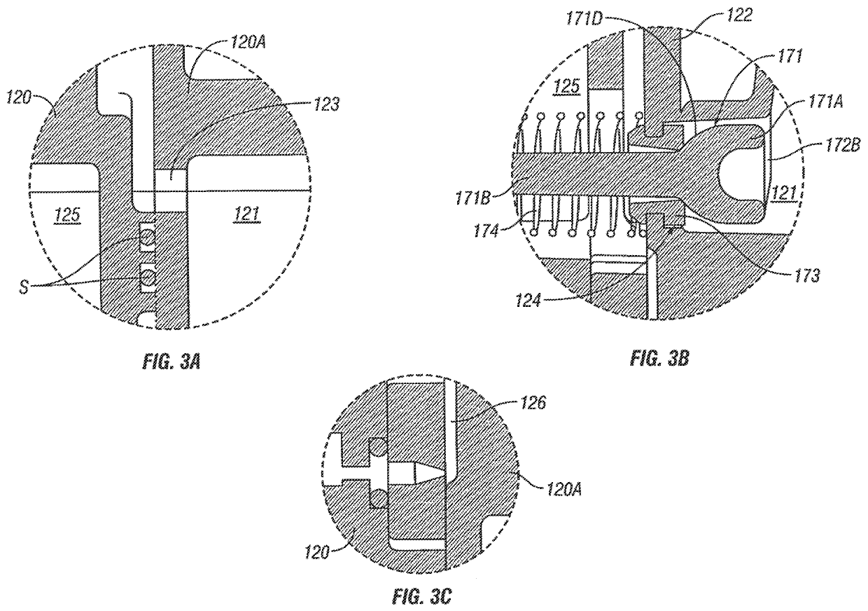

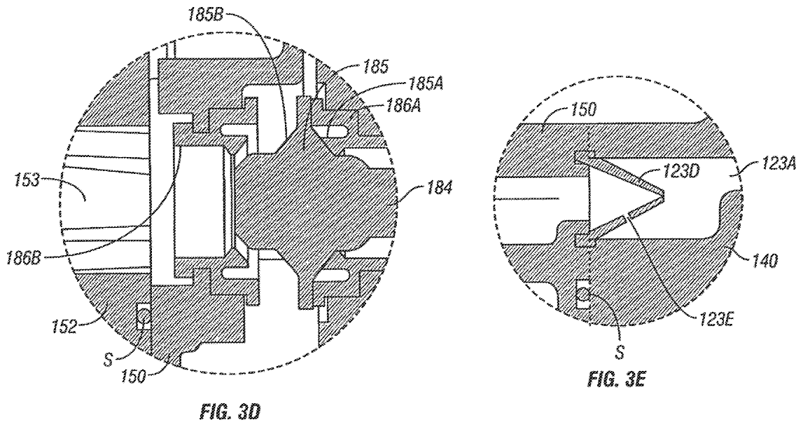

A pressure sensor conduit 43 is disposed in pressure communication with pipe 40 at one of its ends and, at its opposite end, is coupled to a pressure sensor port 111 of section 110. Port 111 opens into a first chamber 113 which is defined by a wall 114 of section 110 and a flexible diaphragm 160. A second chamber 121 is located on the opposite side of diaphragm 160 and is formed by diaphragm 160 and a wall 122 of section 120A. Chamber 121 is normally vented to atmosphere through a port 123 (FIGS. 3 and 3A). A port 124 extends through wall 122 providing an air flow path between chambers 121 and 125 (FIG. 3B).

A valve and actuator assembly 170 (FIGS. 3 and 3B) is located in second chamber 121 and is used to selectively allow flow between chambers 121 and 125. Valve and actuator assembly 170 includes a sealing member 171, an actuating lever 172, a seal seat 173, a biasing means 174 and a retainer 175. In the embodiment shown, biasing means 174 is a spring. Sealing member 171 in the embodiment shown includes a head portion of 171A with a shaft 171B extending from a rounded surface 171D. An opening 171C extends through the free end of shaft 171B. Lever 172 includes a first end 172A and a second end 172B. Seal seat 173 is positioned in port 124. Sealing member 171 and lever 172 are located in chamber 121 on one side of wall 122. Shaft 171B extends through seal seat 173. Note that rounded surface 171D of sealing member 171 is self-centering on seal seat 173. Biasing means 174 is positioned on the opposite side of wall 122 and is positioned around shaft 171B. Shaft 171B extends through retainer 175 and is secured in place by inserting pin 175A through opening 171C in shaft 171B.

A third chamber 125 is formed by wall 122 and a diaphragm 161. A port 126 (FIGS. 3 and 3C) extends between sections 120A and 120 of controller 80 and communicates with chamber 125.

A fourth chamber 127 is formed by diaphragm 161 and a wall 131 of section 130. A generally cylindrical rod 180 abuts and extends laterally from diaphragm 161, through an opening 181 in wall 131 and through a seal 182 positioned in opening 181 to prevent fluid or pressure leakage from chamber 127. A biasing means 183 (which is a spring in the embodiment shown) is located between diaphragm 161 and a wall 131 to maintain diaphragm 161 in the standby position illustrated in FIG. 3.

A fifth chamber 141 is located on the opposite side of wall 131 from chamber 127 and is formed by wall 131 and a wall 142 of section 140. A vacuum port 143 extends from section 140 and connects to a vacuum line that communicates with the vacuum side of discharge conduit 50 through check valve 500 as described in greater detail below. Tapered rod 184 extends from rod 180 opposite diaphragm 161. In the standby position illustrated in FIG. 3, all of tapered rod 184 is located in chamber 141 to preclude leakage of vacuum or low pressure therefrom.

A sixth chamber 151 is defined by wall 142 and wall 152 of section 150. An atmospheric pressure port 153 extends from wall 152 and is in communication with chamber 151. A valve connection port 154 also extends from section 150.

A sealing member 185 (FIGS. 3 and 3D) having a first sealing side 185A and a second sealing side 185B is secured to one end of shaft 184. A first valve seat 186A is located in an opening 142A in wall 142 through which shaft 184 extends. A second valve seat 186B is located adjacent the opening to port 153. When the controller is in the standby condition of FIGS. 3 and 3D, side 185A of sealing member 185 engages valve seat 186A to prevent vacuum communication from chamber 141 with chamber 151 and valve connection port 154. In this position, chamber 151 and valve connection port 154 are under atmospheric pressure as a result of being in communication with atmospheric pressure port 153.

Port 123 is in communication with port 153 through a flow path 123A and two ports 123B (FIG. 3). An air filter 123C and a duck bill valve 123D (FIGS. 3 and 3E) are located in flow path 123A between port 123 and port 123B. Note that duck bill valve 123D includes a port 123E through which air at atmospheric pressure can flow even when orifice 123D is closed as shown in FIGS. 3 and 3E.

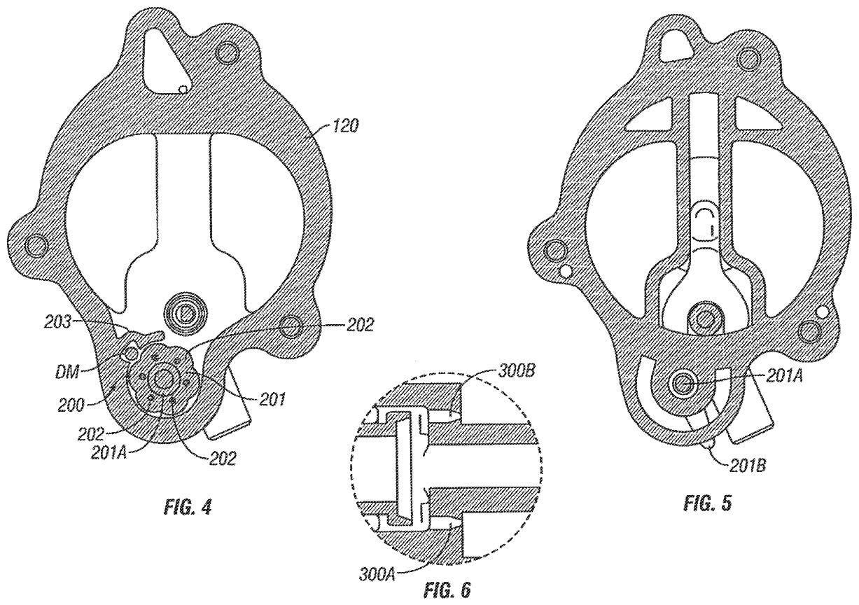

The speed of air flow through and pressure equalization between chambers 121, 125, 127 and 141 is controlled by port 126 and a series of orifices, valves and chambers. Chamber 125 is in communication with chamber 126A through port 126 and adjustable orifice 200 (FIGS. 3 and 4). Adjustable orifice 200 includes notched member 201 having a plurality of orifices 202 of varying sizes extending therethrough. Member 201 is mounted on a rotatable shaft 201A in section 120 adjacent wall 122. A portion 203 of section 120 retains member 201 in controller 80. A lever 201B may be used to rotate member 201 to align the orifice 202 of the desired size such that it is in communication with port 126 as shown in FIGS. 4 and 5. A detent member DM is provided adjacent member 201. In one embodiment, detent member DM is a compressible member, that locates within successive recesses of notched member 201 as it is rotated, thereby indicating alignment of successive orifices 202 with port 126.

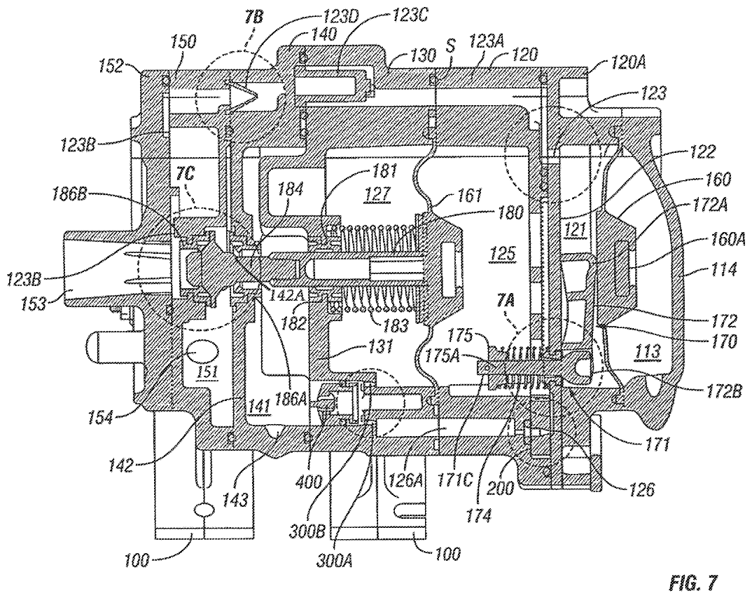

Chamber 126A can communicate with chambers 127 and 141 through orifices 300A and B and check valve 400 (FIGS. 3 and 6). Check valve 400 is in the open position when controller 80 is in the standby state. This serves, through vacuum port 143, ports 126 and orifices 200, 300A and 300B, to maintain equalized pressure in chambers 125, 127 and 141 at the low or vacuum pressure of the section of conduit 50 downstream from valve 70 during standby. Fluid communication between chambers 125, 127 and 141 is achieved and controlled by this series of ports, orifices and valves, as described in greater detail below.

Vacuum is supplied to controller 80 through a vacuum line 143A, which is connected to at one end to vacuum port 143 in a manner known in the art, such as the one disclosed in U.S. Pat. No. 4,171,853, and at the opposite end to check valve 500. Vacuum line 143A communicates through check valve 500 with the section of discharge conduit 50 downstream from valve 70 and thereby supplies a constant low pressure or vacuum source to the controller through vacuum line 143A and vacuum port 143. In the standby state, chamber 151 is maintained at atmospheric pressure through an air breather (not shown) which communicates with port 153 in a manner known in the art. The controller communicates with the valve 70 through valve connector port 154, which is in pressure communication with the upper end 71 of valve 70.

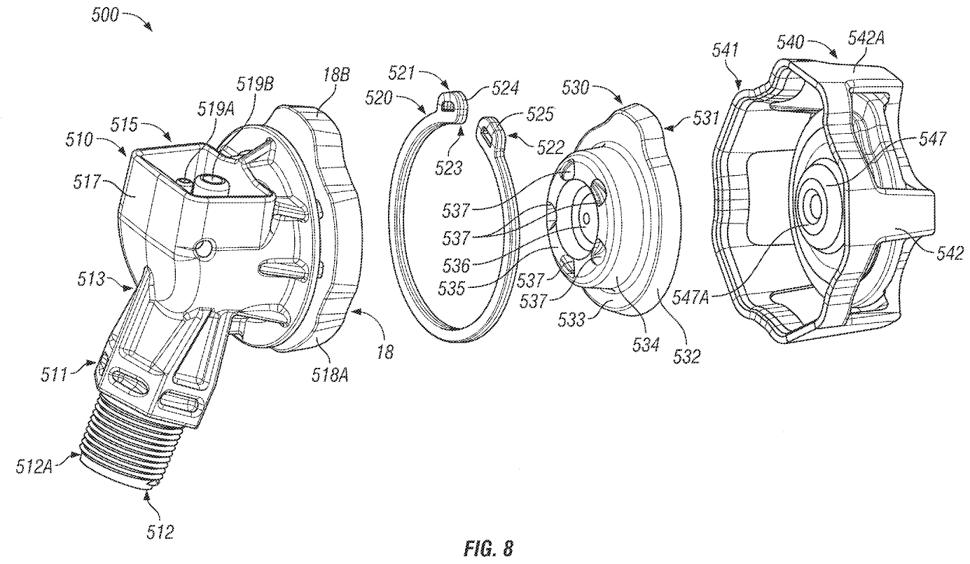

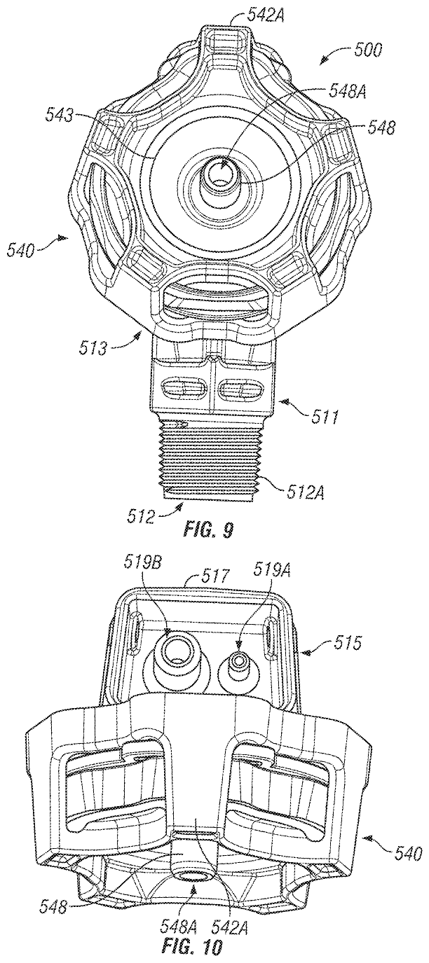

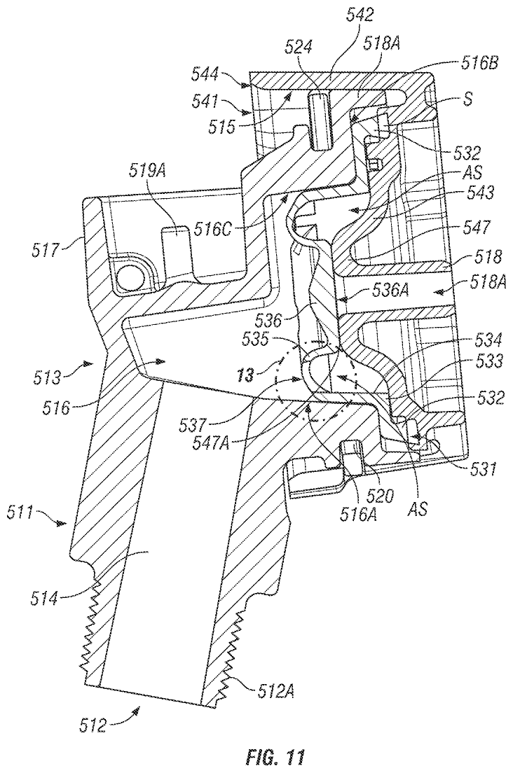

FIG. 8 is an exploded perspective view of check valve 500 according to one embodiment of the present invention. Check valve 500 generally includes a main body 510, a retaining member 520, a sealing element 530, and a cover 540.

Referring to FIGS. 8, 11 and 12, main body 510 in the embodiment shown includes a post 511 having a first end 512 and a second end 513. First end 512 includes threads 512A. Threads 512A engage corresponding threads in a threaded opening (not shown) in valve 70 to secure main body 510 to valve 70. Post 511 has an interior passageway 514 extending from first end to 512 and second end 513. Main body 510 further includes a housing 515 having an interior chamber 516, a closed end 517, and an open end 518. Chamber 516 is in fluid communication with passageway 514 of post 511 and includes a lower surface or floor 516A, a first sealing surface 516B, and a second sealing surface 516C. Open end 518 has a circumferential flange 518A having an enlarged or protruding section 518B. Housing 515 is disposed relative to post 511 such that floor 516A of chamber 516 angles downwardly toward interior passageway 514 of post 511. Housing 515 further includes a peripheral groove 518C positioned between closed end 517 and open end 518. Housing 515 also includes an electronic air admission controller (EAAC) port 519A and a monitor connector 519B. Port 519A can be used to connect an EAAC of types known in the art to check valve 500. The EAAC can be used to selectively introduce air into vacuum sewage system 10 as is known in the art. Connector 519B can be used to connect monitoring equipment to check valve 500 to obtain data and report the operating condition of vacuum sewage system 10.

Retaining member 520 is a substantially annular member having a first end 521, a second end 522 and an opening 523. First end 521 has an enlarged section or protrusion 524 and second end 522 also has an enlarged section or protrusion 525. Retaining member 520 is a flexible or compressible resilient member. Force may be applied to first end 521 and/or second end 522 to move first end 521 and second end 522 closer together or farther apart, thereby increasing or decreasing the size of opening 523. When the force is removed, first end 521 and second end 522 return to the positions shown in FIG. 8, thereby restoring the size of opening 523 to that shown in FIG. 8.

Sealing member 530 is a disk-like member having a front face 531, a first section or flange 532, a second section 533 extending from first section 532, a third section 534 extending from second section 533, a curved or undulating section 535 connected to third section 534, and a central or sealing section 536 connected to curved section 535. Sealing surface 536 has a sealing surface 536A. Curved section 535 includes a plurality of openings 537 spaced around central or sealing section 536. Peripheral wall 532 includes an enlarged or protruding section 532A. Sealing member 530 is constructed from a resilient and flexible material suitable for performing the functions described herein. For example, sealing member 530 may be constructed from rubber.

Cover 540 in the embodiment shown has an open end 541, a peripheral side wall 542 and a front wall 543. Side wall 542 has a beveled edge 544 and an inner surface 545. Side wall 542 and front wall 543 are arranged so as to form an interior chamber 546 in cover 540. The periphery of wall 542 is configured so as to have an enlarged or protruding section 542A. Front wall 543 includes a central section 547 having a sealing surface 547A. A seal S is positioned on front wall 543 spaced apart from and around central section 547. A connector 548 extends from central section 547 of cover 540. Connector 548 has a passageway 548A in fluid communication with interior chamber 546 of cover 540. Cover 540 further includes an interior recess or groove 549 for receiving flange 518A of main body 510 as described below.

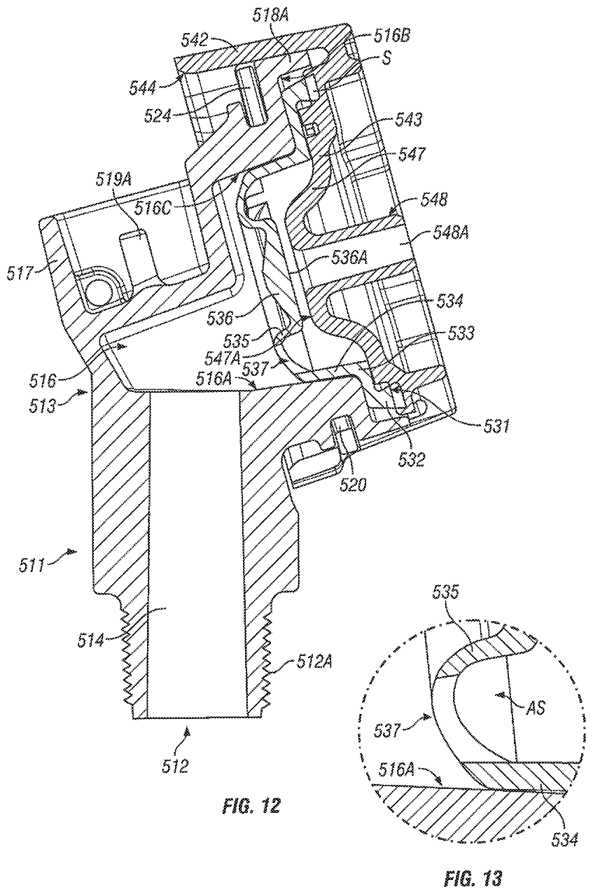

To assemble check valve 500, retaining member 520 is positioned in groove 518C of housing 515. Sealing member 530 is inserted in chamber 516 of housing 515 such that second section 533 of sealing member 530 contacts first sealing surface 516B of chamber 516 and third section 534 of sealing member 530 is adjacent second sealing surface 516C of chamber 516. Note that in order to insert sealing member 530 into chamber 516, sealing member 530 must be oriented such that protruding section 532A is aligned with protruding section 518B of flange 518. In this manner, sealing member 530 can only be inserted into chamber 516 in one orientation. Protruding section 532A nests within protruding section 518B when sealing member 530 is inserted in chamber 516. After sealing member 530 is inserted in chamber 516, cover 540 is slid over flange 518 of housing 515 such that flange 518 is positioned with groove 549 and second section 533 of sealing member 530 is positioned between first sealing surface 516B of chamber 516 and front wall 543 of cover 540 as shown in FIGS. 11 and 12. As cover 540 is slid toward housing 515, beveled edge 544 of cover 540 contacts enlarged sections 524 and 525 of first end 521 and second end 522, thereby compressing retaining member 520 inward toward groove 518C. When enlarged sections 524 and 525 clear beveled edge 524, they exert force outwardly on inner surface 545 of side wall 542 to secure cover 540 to main body 510. Note that in order to secure cover 540 to housing 515, cover 540 must be oriented such that protruding section 542A is aligned with protruding section 518B of flange 518 and with protruding section 532A of sealing member 530. In this manner, cover 540 can only be positioned on housing 515 in one orientation, with protruding section 518B nested within protruding section 542A of cover 540.

When check valve 500 is assembled as shown in FIGS. 11 and 12, seal S is clamped between front face 531 of sealing member 530 and front wall 543 of cover 540. Sealing member 530 is clamped in place around its entire periphery via the positioning of second section 533 of sealing member 530 between first sealing surface 516B of chamber 516 and front wall 543 of cover 540. Securing sealing member 530 within chamber 516 in this manner helps prevent undesirable distortion of sealing member 530 under pressure surges that can occur during operation by providing a greater area of support to sealing member 530 as compared to other check valve configurations, such as ones that utilize a sealing member centrally mounted on a post. The curved or undulating shape of curved section 535 of sealing member 530 also resists undesirable distortion and results in a check valve having a low cracking pressure. As used in this disclosure, “low cracking pressure” as applied to check valve 500 is a cracking pressure that does not cause a reduction of the vacuum supply to controller 80 that would prevent controller 80 from actuating at the desired vacuum level. In certain embodiments of the invention, a low cracking pressure is one that does not prevent actuation of controller 80 at a vacuum pressure of 5 inches of mercury. In certain embodiments of the invention, a low cracking pressure is less than 1 inch of mercury vacuum.

Check valve 500 is secured to valve 70 by threading first end 512 of post 511 into a corresponding threaded opening on valve 70. Vacuum line 143A is connected at one end to connector 548 of cover 540 and at the opposite end to vacuum port 143 of controller 80.

FIG. 11 illustrates check valve 500 in the standby state, i.e., the state of check valve 500 when controller 80 is in the standby state shown in FIG. 3. In this state, sealing surface 536A of sealing member 530 is in contact with sealing surface 547A of cover 540, and an annular space AS is formed between curved section 535 of sealing member 530 and front wall 543 of cover 540. In the standby state, check valve 500 holds the existing vacuum in controller 80 and prevents reverse flow of liquid and debris into controller 80.

Note that check valve 500 includes a number of features designed to remove moisture and debris from check valve 500. Openings 537 in sealing member 530 are larger than the smallest cross-section of passageway 548A of connector 548. Thus, any debris that is large enough to pass through passageway 548A can also pass from one side of sealing member 530 to the opposite side through openings 537. The smallest cross-section of passageway 514 of post 511 is also larger than the smallest cross-section of passageway 548A. Thus, any debris that can pass through passageway 548A can also pass through passageway 514 and out of check valve 500. Moisture can also flow from one side of sealing member 530, through openings 537, to the opposite side of sealing member 530, and out of check valve 500 via passageway 514. Second, disposing floor 516A of chamber 516 at a downward angle to passageway 514 assists in draining moisture and debris out of chamber 516 via passageway 514. Removing moisture from check valve 500 is desirable in certain operating conditions, such as cold weather environments in which moisture that accumulates in check valve 500 can freeze and interfere with operation of check valve 500.

In certain embodiments of the invention, openings 537 and passageway 514 are designed such that they do not restrict the flow of air through controller 80, which could result in controller 80 not actuating or operating as desired. Accordingly, in certain embodiments of the invention, the rate of air flow through check valve 500 is greater than the rate of air flow through controller 80. In certain embodiments of the invention, this higher flow rate through check valve 500 is achieved by making openings 537 and the smallest cross-section of passageway 514 larger than the largest cross-section of the various ports and air flow paths of controller 80, such as port 123, flow path 123A, ports 123B, orifice 123D, port 123E, port 124, port 126, opening 142A, vacuum port 143, vacuum line 143A, atmospheric pressure port 153, valve connection port 154, adjustable orifice 200, orifices 202, orifice 300A, orifice 300B, and check valve 400.

In operation, controller 80 begins in the standby state illustrated in FIG. 3. In this state, head portion 171A of sealing member 171 is seated on seal seat 173 by the force of biasing means 174 and the pressure differential between chambers 121 (which is at atmospheric pressure) and chamber 125 (which is at low or vacuum pressure). Check valve 500 is also in the standby state shown in FIG. 11.

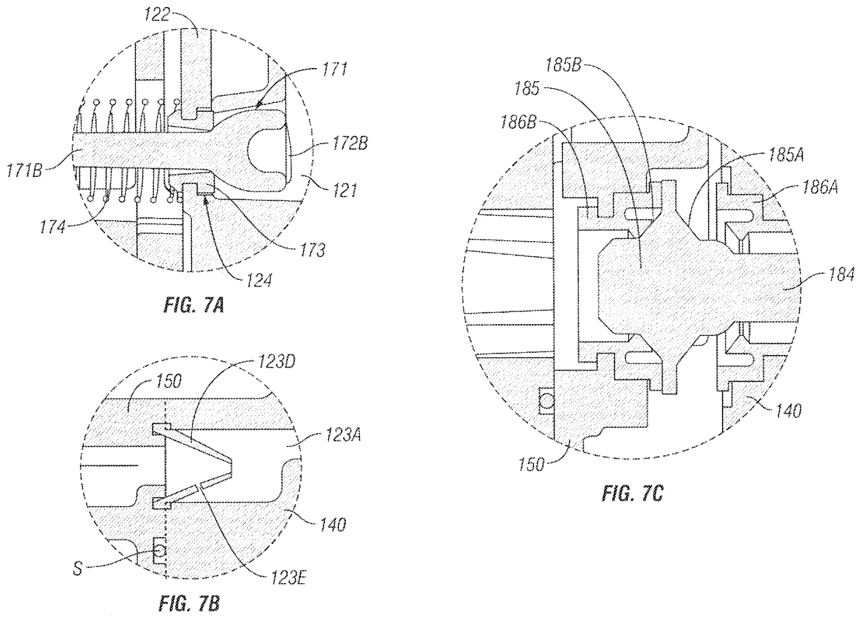

Sewage accumulation in tank 30 produces pressure in pipe 40, which is communicated to chamber 113 through pressure sensor port 111 through conduit 43. This pressure increase urges diaphragm 160 toward wall 122 as shown in FIG. 7. As diaphragm 160 moves toward wall 122, it applies pressure to first end 172A of lever 172. This in turn causes first end 172A to move toward wall 122 and second end 172B to pivot away from wall 122. As second end 172B pivots away from wall 122, it draws head portion 171A of sealing member 171 away from sealing seat 173 against the biasing force of biasing means 174, as illustrated in FIG. 7A. This establishes fluid and atmospheric pressure communication between chambers 121 and 125 as atmospheric air flows from port 153, through flow path 123A and through port 123 into chamber 121 and through port 124. Note that the flow of air causes duck bill valve 123D to open as shown in FIG. 7B. Alternatively, if check valve 600 is used, the flow of air through passageways 604 and opening 150A will cause flange 603 to unseat from section 150 to permit increased air flow.

As the low or vacuum pressure in chamber 125 is increased by the introduction of air at atmospheric pressure, diaphragm 161 is urged toward wall 131 by the combination of the increased pressure in chamber 125 and the low or vacuum pressure in chamber 127. This causes rod 180 and tapered rod 184 to move toward wall 152. As this occurs, first sealing side 185A of sealing member 185 disengages valve seat 186A and second sealing side 185B seats against valve seat 186B, thereby closing atmospheric air port 153 against further communication of atmospheric air into chamber 151 and valve connector port 154. As first sealing side 185A moves away from valve seat 186A, fluid and pressure communication between chambers 141 and 151 is established as air flows around sealing member 155 and tapered post 184. This exposes chamber 151 to low or vacuum pressure from vacuum port 143. This also increases the pressure in chamber 141 and causes air flow through vacuum port 143 toward check valve 500, which causes sealing surface 536A of sealing member 530 to move away from and to become spaced apart from sealing surface 547A of cover 540 as shown in FIG. 12.

As the atmospheric pressure communicating with valve 70 through valve connector port 154 is decreased under the influence of vacuum pressure from chamber 141, valve 70 is activated in a manner known in the art, such as the manner described in U.S. Pat. No. 4,179,371. As valve 70 is opened, the upstream portion of discharge conduit 50 is placed under low or vacuum pressure. Since tank 30 is essentially at atmospheric pressure, the low or vacuum pressure in discharge conduit 50 causes the sewage to be discharged into discharge conduit 50 and transported to collection station CT.

The discharge of sewage from tank 30 produces an almost immediate drop of pressure in communication with diaphragm 160 through pipe 40, thereby reducing the pressure in chamber 113. This draws diaphragm 160 away from wall 122 and first end 172A of lever 172. As a result, head portion 171A of sealing member 171 is urged against sealing seat 173 under the influence of biasing means 174, thereby preventing flow from chamber 121 to chamber 125 through port 124. This causes the vacuum in chambers 141 and 151 to drop, resulting in the closure of check valve 400 as the pressure in chambers 125 and 127 begins to equalize. The rate of equalization is controlled by the size of orifices 200, 300A and 300B and by the size of chamber 126A. For example, the smaller the orifices, the slower the equalization of pressure between the various chambers. Similarly, the larger the volume of chamber 126A, the longer the equalization time between the various chambers, as the larger reservoirs have greater volume that needs to be equalized. Use of larger volumes permits use of larger orifices, which in turn allows moisture to pass through controller 80 before the system vacuum is depleted. This also eliminates the need for dip tubes.

As the differential pressures in chambers 125 and 127 equalize, the diaphragm 161 moves toward wall 122 and draws first sealing side 185A back against valve seat 186A. This opens atmospheric air port 153. Atmospheric air pressure again communicates through valve connector port 154 and the resulting pressure change closes valve 70. The movement of sealing member 185 also prevents low or vacuum pressure from being transmitted from chamber 141 to chamber 151. When this occurs, check valve 400 resumes its normally open condition and pressure across chambers 125, 127 and 141 is equalized to that of the vacuum line pressure of conduit 50.

As controller 80 returns to the standby state, check valve 500 also returns to the standby state of FIG. 11. Up until the time at which sealing surface 536A of sealing member 530 contacts sealing surface 547A of cover 540, vacuum is supplied to controller 80 through passageway 514 of post 511, chamber 516 of housing 515, openings 537 of sealing member 530, passageway 548A of connector 548, vacuum line 143A, and vacuum port 143.

As noted above, backpressure can sometime occur during operation of vacuum sewage system 10. This backpressure can force sewage from discharge conduit 50 into controller 80 via vacuum port 143. However, in vacuum sewage systems according to the present invention, backpressure through passageway 514 and chamber 516 will force central section 536 of sealing member 530 toward central section 547 of front wall 543 of cover 540 so that sealing surface 536A of sealing member 530 seals against sealing surface 547A as shown in FIG. 11, thereby closing off access to passageway 548A of connector 548 and preventing sewage from entering controller 80. Sewage and moisture that may have accumulated in annular space AS under such backpressure conditions can drain through openings 537 and out of check valve 500.

As noted above, vacuum pumps VP are cycled on and off to maintain the appropriate level of vacuum in the vacuum sewage system, including in controller 80. Check valve 500 will be activated if vacuum pumps VP cycle on while check valve 500 is in the standby state. Specifically, activation of vacuum pumps VP when check valve 500 is in the standby state will cause sealing member 530 to move toward closed end 517 of main body 510, which moves sealing surface 536A of sealing member 530 away from sealing surface 547A of cover 540 as shown in FIG. 12. With sealing member 530 in this position, vacuum is supplied to controller 80 through passageway 514 of post 511, chamber 516 of housing 515, openings 537 of sealing member 530, passageway 548A of connector 548, vacuum line 143A, and vacuum port 143. Check valve 50 will return to the standby state of FIG. 11 after vacuum pumps VP cycle off.

Although the present invention has been shown and described in detail the same is by way of example only and is not a limitation on the scope of the present invention. Numerous modifications can be made to the embodiments shown and described without departing from the scope of the present invention. For example, although check valve 500 has been described in connection with preventing sewage backflow into controller 80 via vacuum line 143A, check valve 500 can be utilized in other locations in vacuum sewage system 10 where it is desirable to prevent backflow. Retaining member 520 could be eliminated and the remaining components of check valve 500 could be secured together by alternate means, such as by configuring main body 510 and cover 540 such that they interlock or snap-fit together.

What is claimed is:

1. A check valve for a vacuum sewage system, including:
a body, the body including a post and a housing, the post having a first end, a second end and a passageway extending from the first end to the second end, the housing having a groove, an open end, a flange disposed about the open end and having a protrusion, a closed end and a chamber in fluid communication with the post passageway, the chamber having a floor disposed at an angle to the post passageway, a first sealing surface and a second sealing surface;
a sealing member, the sealing member having a front face, a first section having a protrusion, a second section extending from first section, a third section extending from second section, a curved section connected to third section and having at least one opening, and a central section connected to curved the section, the central section having a sealing surface;
a cover, the cover including an open end, a side wall having a protrusion, a beveled edge and an inner surface, a front wall having a central section having a sealing surface, an interior chamber, an interior groove, and a connector extending from the front wall, the connector having a passageway in communication with the interior chamber;
a retaining member for securing the cover to the housing of the main body, the retaining member located in the groove of the main body and having a first end, a second end and an opening between the first end and the second end; and
wherein, the flange of the housing is located in the interior groove of the cover, the second section of the sealing member is located between the first sealing surface of the housing chamber and the front wall of the cover, the second section of the sealing member is located adjacent the second sealing surface of the housing chamber, the protrusion of the sealing member is located in the protrusion of the housing, and the protrusion of the sealing member and the protrusion of the housing flange are located in the protrusion of the cover.

2. The check valve according to claim 1, wherein at least a portion of the floor of the chamber housing angles downwardly from the open end toward the post passageway.

3. The check valve according to claim 1, wherein the central section of the sealing member is moveable from a first position in which the sealing surface of the sealing member is in contact with the sealing surface of the central section of the front wall of the cover, to a second position in which the sealing surface of the central section of the sealing member is spaced apart from the sealing surface of the central section of the front wall of the cover.

4. The check valve according to claim 3, wherein the sealing surface of the central section of the sealing member closes one end of the connector passageway when the central section of the sealing member is in the first position.

5. The check valve according to claim 3, wherein an annular space is formed around the central section of the front wall of the cover and between the curved section of the sealing member and the front wall of the cover when the central section of the sealing member is in the first position.

6. The check valve according to claim 1, wherein the at least one opening in the sealing member is larger than the smallest cross-section of the connector passageway.

7. The check valve according to claim 1, wherein the smallest cross-section of the post passageway is larger than the smallest cross-section of the connector passageway.

8. The check valve according to claim 1, wherein the at least one opening in the sealing member and the smallest cross-section of the post passageway are both larger than the smallest cross-section of the connector passageway.

9. The check valve according to claim 1, wherein the retaining member exerts outward force on the inner surface of the sidewall of the cover.

10. The check valve according to claim 1, wherein the housing further includes a port for connection to an electronic air admission controller.

11. The check valve according to claim 1, wherein the housing further includes a connector for a device for monitoring the operational state of the vacuum sewage system.

12. A check valve for a vacuum sewage system, including:
a body, the body including a housing;
a sealing member, the sealing member having a first section and a central section connected to the first section, the central section of the sealing member having a sealing surface;
a cover, the cover including an interior chamber, a connector having a passageway in communication with the interior chamber, and a front wall having a central section, the central section of the front wall having a sealing surface; and
wherein the central section of the sealing member is moveable from a first position in which the sealing surface of the sealing member is in contact with the sealing surface of the central section of the front wall of the cover, to a second position in which the sealing surface of the central section of the sealing member is spaced apart from the sealing surface of the central section of the front wall of the cover.

13. The check valve according to claim 12, wherein the sealing surface of the central section of the sealing member closes one end of the connector passageway when the central section of the sealing member is in the first position.

14. The check valve according to claim 12, wherein an annular space is formed around the central section of the front wall of the cover and between the first section of the sealing member and the front wall of the cover when the central section of the sealing member is in the first position.

15. The check valve according to claim 12, further including at least one opening in the sealing member.

16. The check valve according to claim 15, wherein the at least one opening is in the first section of the sealing member.

17. The check valve according to claim 15, wherein the at least one opening in the sealing member is larger than the smallest cross-section of the connector passageway.

18. The check valve according to claim 14, further including an opening in the sealing member in fluid communication with the annular space.

19. The check valve according to claim 12, wherein the housing includes an open end and a chamber, and the body further includes a post having a first end, a second, and a passageway in fluid communication with the chamber and extending from the first end of the post to the second end of the post.

20. The check valve according to claim 19, wherein the chamber includes a floor, at least a portion of which angles downwardly from the open end toward the post passageway.

21. A check valve for a vacuum sewage system, including:
a body, the body including a housing;
a cover, the cover including an interior chamber, a connector having a passageway in communication with the interior chamber, and a front wall having a central section, the central section of the front wall having a sealing surface; and
a sealing member, the sealing member having a first section and a central section connected to the first section, the central section of the sealing member having a sealing surface facing the front wall of the cover; and
means for facilitating the passage of fluid from between the sealing member and the front wall of the cover to the opposite side of the sealing member.

22. The check valve according to claim 21, wherein the means for facilitating the passage of fluid includes at least one opening in the sealing member.

23. A vacuum sewage system, including:
a controller;
a vacuum pump for providing vacuum to the vacuum sewage system and to the controller; and
a check valve, the check valve having a cracking pressure sufficiently low so as to not cause a reduction of the vacuum supply to the controller upon opening of the check valve.

24. The vacuum sewage system according to claim 23, wherein the cracking pressure is less than 1 inch of mercury vacuum.

25. The vacuum sewage system according to claim 23, wherein the controller is actuated at a vacuum pressure of 5 inches of mercury.

26. The vacuum sewage system according to claim 23, wherein the rate of air flow through the check valve is greater than the rate of air flow through the controller.
